(19) United States
(12) Patent Application Publication
(10) Pub. No.: US 2025/0359696 A1
(43) Pub. Date: Nov. 27, 2025

(54) CHRISTMAS TREE STAND

(71) Applicant: Huizhou Zhuoyi Crafts Co., LTD, Huizhou (CN)

(72) Inventor: Hua Li, Huizhou (CN)

(21) Appl. No.: 19/295,214

(22) Filed: Aug. 8, 2025

(51) Int. Cl. A47G 33/12; A47G 33/08; F16M 11/38

(52) U.S. Cl. CPC A47G 33/126; A47G 33/0818; F16M 11/38; A47G 2033/122; A47G 2033/1266

(57) ABSTRACT

The invention discloses a Christmas tree stand, which comprises a rotating seat, a fixing seat, a driving mechanism and a plurality of supporting legs. The middle and lower ends of the rotating seat are inserted into an internal cavity of the fixing seat, the driving mechanism is fixedly installed in the internal cavity of the fixing seat, so that the rotating seat and the driving mechanism are coaxially arranged, and the driving mechanism is connected to the rotating seat, enabling the rotating seat and the Christmas tree to rotate synchronously. Since the rotating seat and the driving mechanism are coaxially assembled in the internal cavity of the fixing seat, transmission gears and annular external teeth are always in an ideal engaged state; space can be fully utilized to closely integrate the driving mechanism with the rotating seat.

### TECHNICAL FIELD

The invention relates to the technical field of stands, in particular to a Christmas tree stand.

### BACKGROUND ART

In the field of Christmas decorations, the Christmas tree, as the core element, requires a striking display effect. To enhance the ornamental appeal of the Christmas tree and showcase its decorations from all angles, rotating Christmas tree stands have been developed.

Currently, rotating Christmas tree stands feature a transmission gear at the bottom of the rotating seat, while the drive and the drive wheel are externally configured. During operation, the drive motor rotates the drive wheel. The drive wheel transmits power to the transmission gear through engaged transmission with the transmission gear, which in turn drives the rotating seat to rotate, ultimately enabling the Christmas tree to rotate for display.

However, this existing driving mechanism has evident drawbacks. On one hand, additional space is required for installing and arranging these components because the drive motor and drive wheel are externally positioned, resulting in a relatively large assembly space for the entire Christmas tree stand. This not only increases the volume of the product but also demands more space for packaging, transportation, and storage, thereby raising costs. Moreover, in some usage scenarios with limited space, such as small indoor spaces or specific display areas, the large assembly footprint may limit the product's use and installation, reducing its applicability and flexibility. On the other hand, the transmission gears and the drive wheels are positioned on different axes. This configuration demands accurate positioning and fine-tuning of the two engaged gears to ensure smooth and reliable power transmission. However, in actual use, the transmission gears and the drive wheels are susceptible to misalignment caused by factors such as manufacturing defects, assembly precision, and wear over prolonged use. This misalignment leads to poor engagement between gears, resulting in issues such as noise and vibration that affect the rotation performance and stability of the Christmas tree. In severe cases, it can cause gear damage, shortening the product's lifespan, increasing maintenance costs and inconveniencing users.

### SUMMARY OF THE INVENTION

To address the shortcomings of the existing technical proposals, the invention provides a Christmas tree stand that effectively resolves the technical issues identified in the background prior art.

The invention adopts the following technical proposal to solve the technical problems: a Christmas tree stand comprises a rotating seat, a fixing seat, a driving mechanism and a plurality of supporting legs, a slot is arranged in the middle of the rotating seat to accommodate the bottom of the trunk of a Christmas tree, the middle and lower ends of the rotating seat are inserted into an internal cavity of the fixing seat, the driving mechanism is fixedly installed in the internal cavity of the fixing seat, so that the rotating seat and the driving mechanism are coaxially arranged, and the driving mechanism is connected to the rotating seat to drive the rotating seat and the Christmas tree to rotate synchronously.

Further, positioning bumps are formed on the outer wall of the rotating seat. A first bearing, a sleeve and a second bearing are successively sleeved at the middle and lower ends of the rotating seat, a first annular bump is formed on the inner wall of the fixing seat, the second bearing is arranged on the surface of the first annular bump and abutted against the first annular bump, the first bearing is arranged at the bottom of the positioning bumps and abutted against the positioning bumps, the sleeve is arranged between the first bearing and the second bearing, upper and lower end faces of the sleeve are respectively abutted against the first bearing and the second bearing, the sleeve is firmly connected to the fixing seat, and a clearance is reserved between the top of the rotating seat and the top of the fixing seat.

The driving mechanism comprises an installation housing and at least one connecting piece formed on the periphery of the installation housing, a second annular bump is formed on the inner wall of the fixing seat, and the connecting piece is arranged at the bottom of the second annular bump and firmly connected to the second annular bump.

Further, annular external teeth are arranged on the bottom side wall of the rotating seat, the driving mechanism comprises a driving component and a transmission gear, the driving component is assembled on the installation housing and drives the transmission gear to rotate, and the transmission gear is engaged with the annular external teeth to enable the rotating seat to rotate relative to the fixing seat.

Further, the driving mechanism also comprises a conducting component assembled on the installation housing, the conducting component comprises a mounting base, a first conducting column and a second conducting column, a first electrode plate and a second electrode plate are arranged at the bottom of the rotating seat, the first conducting column is electrically connected to the first electrode plate, and the second conducting column is electrically connected to the second electrode plate.

Further, a transmission groove is arranged in the middle of the transmission gear, a transmission shaft matching the shape of the transmission groove is arranged at the output end of the driving component, a first elastic element is sleeved on the outside of the transmission shaft, two ends of the first elastic element are respectively abutted against the lower end face of the transmission gear and the inner wall of the installation housing to enable the transmission gear to perform longitudinal displacement relative to the transmission shaft, and a limit bump is formed at the top of the transmission shaft to prevent the transmission gear from detaching from the transmission shaft.

Further, the mounting base is provided with two sliding grooves, a second elastic element is assembled in each sliding groove, and the first conducting column and the second conducting column are respectively connected to the corresponding second elastic elements, so that the first conducting column and the second conducting column slide up and down inside the sliding grooves.

Further, a bottom cover firmly connected to the fixing seat is arranged at the bottom of the fixing seat, a plurality of supporting legs are distributed in a circular array around the bottom cover, and each supporting leg is connected to the bottom cover through a hinge structure, making the supporting legs rotate relative to the bottom cover.

Further, the bottom cover is hollow inside to form a mounting cavity, a loudspeaker and a main control circuit board are assembled in the mounting cavity, the main control circuit board is electrically connected to the loudspeaker, and the bottom cover is provided with a sound outlet hole.

Further, a wireless transceiver module, a memory module, a Bluetooth module, an audio decoding module and a human-machine interaction module are integrated on the main control circuit board, and the human-machine interaction module comprises a voice acquisition unit, a voice processing unit and a voice output unit.

Further, the Christmas tree stand also comprises at least one fastening screw, one end of the fastening screw is inserted into the slot along the radial direction from the outside of the rotating seat, and the fastening screw is screwed onto the rotating seat.

Compared to the prior art, the invention has the following beneficial effects:

Since the rotating seat and the driving mechanism are coaxially assembled in the internal cavity of the fixing seat, the transmission gears and annular external teeth maintain an ideal engaged state. This ensures that force is transmitted along the precise axis direction when the driving component drives the transmission gear to rotate, preventing transmission shock and vibration caused by eccentricity or angular deviation. As a result, the rotating seat moves smoothly without jamming, significantly enhancing the transmission smoothness. Additionally, this design maximizes space utilization by closely integrating the driving mechanism with the rotating seat, avoiding additional complex transmission structures and redundant space occupation, resulting in a more compact and streamlined device.

### BRIEF DESCRIPTION OF THE DRAWINGS

FIG. 1 is a three-dimensional view of the Christmas tree stand.

FIG. 2 is a cross-sectional view of the Christmas tree stand.

FIG. 3 is an enlarged structural view of Part A in FIG. 2.

FIG. 4 is an exploded structural top view of the Christmas tree stand.

FIG. 5 is an exploded structural bottom view of the Christmas tree stand.

FIG. 6 is an assembly diagram of the rotating seat and the driving mechanism.

FIG. 7 is a three-dimensional view of the driving mechanism.

FIG. 8 is an exploded structural view of the rotating seat.

FIG. 9 is a connection diagram of the Bluetooth module, the audio decoding module and the human-machine interaction module.

FIG. 10 is a block diagram of the receiving module.

FIG. 11 is a circuit diagram of the receiving module.

FIG. 12 is a wiring diagram and screen printing diagram for the top of the receiving module.

FIG. 13 is a wiring diagram and screen printing diagram for the bottom of the receiving module.

FIG. 14 is a block diagram of the remote control.

FIG. 15 is a circuit diagram of the remote control.

FIG. 16 is a wiring diagram and screen printing diagram for the top of the remote control.

FIG. 17 is a wiring diagram and screen printing diagram for the bottom of the remote control.

### REFERENCE SIGNS

1. Rotating seat; 2. Slot; 3. Fastening screw; 4. Fixing seat; 5. Clearance; 6. Bottom cover; 7. Supporting leg; 8. Pad; 9. Positioning bump; 10. First bearing; 11. Sleeve; 12. Mounting cavity; 13. Sound outlet hole; 14. Driving component; 15. Second bearing; 16. First annular bump; 17. Second annular bump; 18. Driving mechanism; 20. Anti-slip protrusion; 21. Installation housing; 22. Connecting piece; 25. Annular external teeth; 26. First electrode plate; 27. Second electrode plate; 28. Mounting base; 29. First conducting column; 30. Second conducting column; 31. Transmission shaft; 32. Limit bump; 33. First elastic element; 34. Second elastic element; 35. Transmission gear; 36. Socket; 37. Wiring duct.

### DETAILED DESCRIPTION OF THE INVENTION

The technical proposals in the embodiments of the invention will be clearly and thoroughly described below with reference to the drawings. It is evident that the described embodiments represent only a portion of the embodiments of the invention, rather than all of them. Based on the embodiments of the invention, all other embodiments obtained by those of ordinary skill in the art without creative efforts shall fall within the protection scope of the invention.

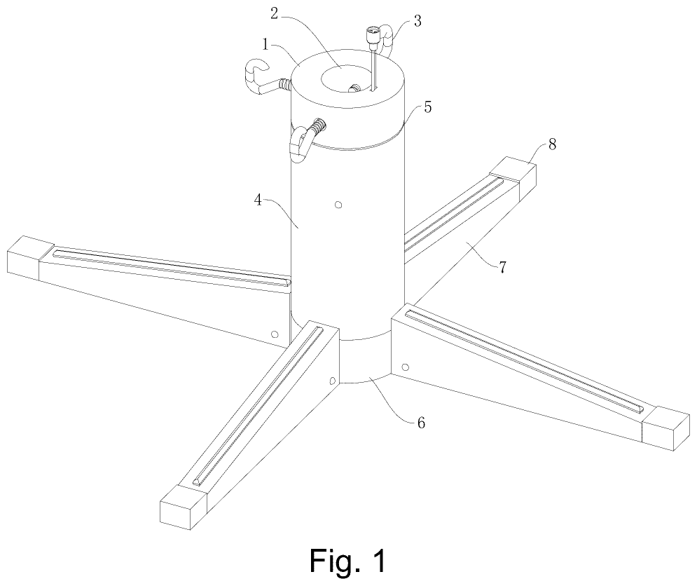

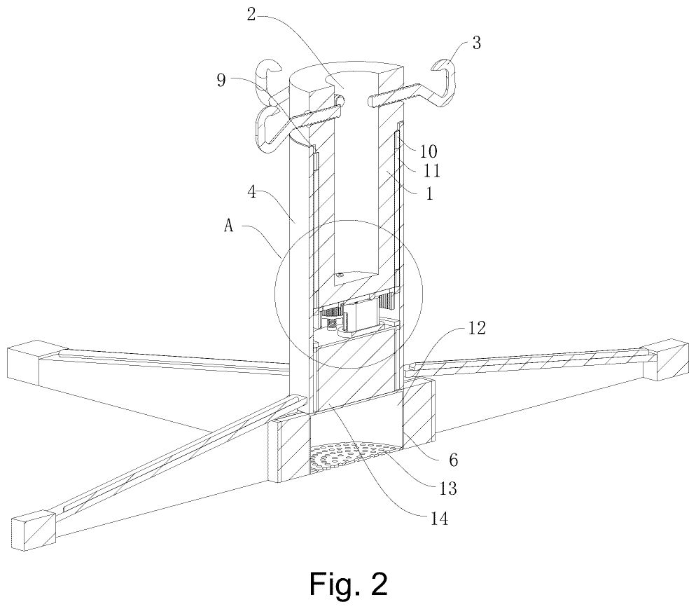

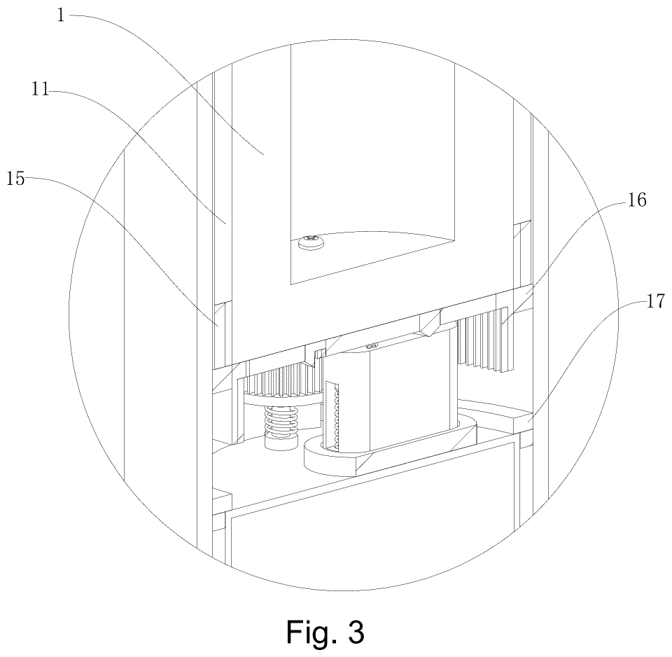

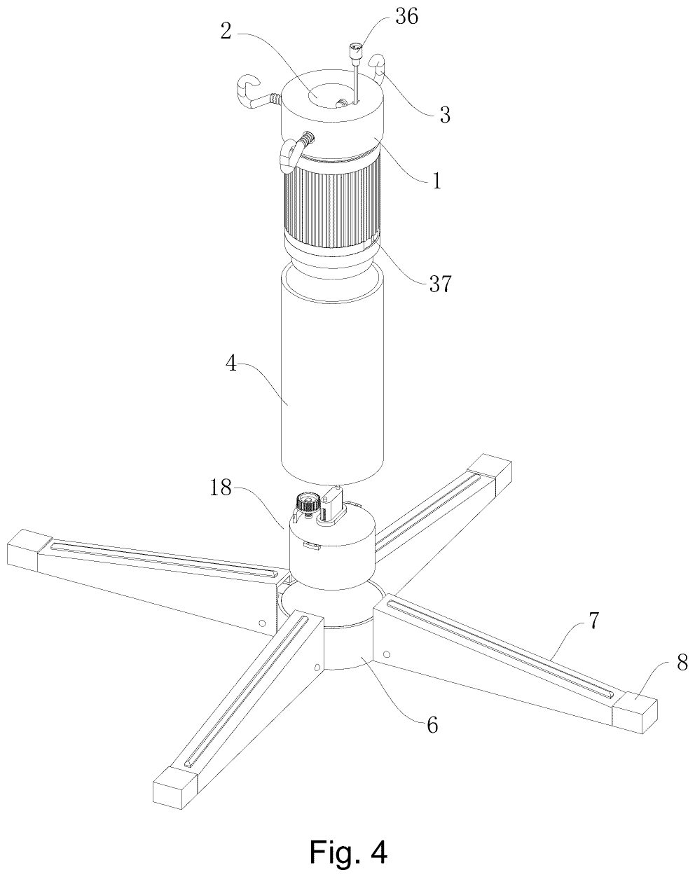

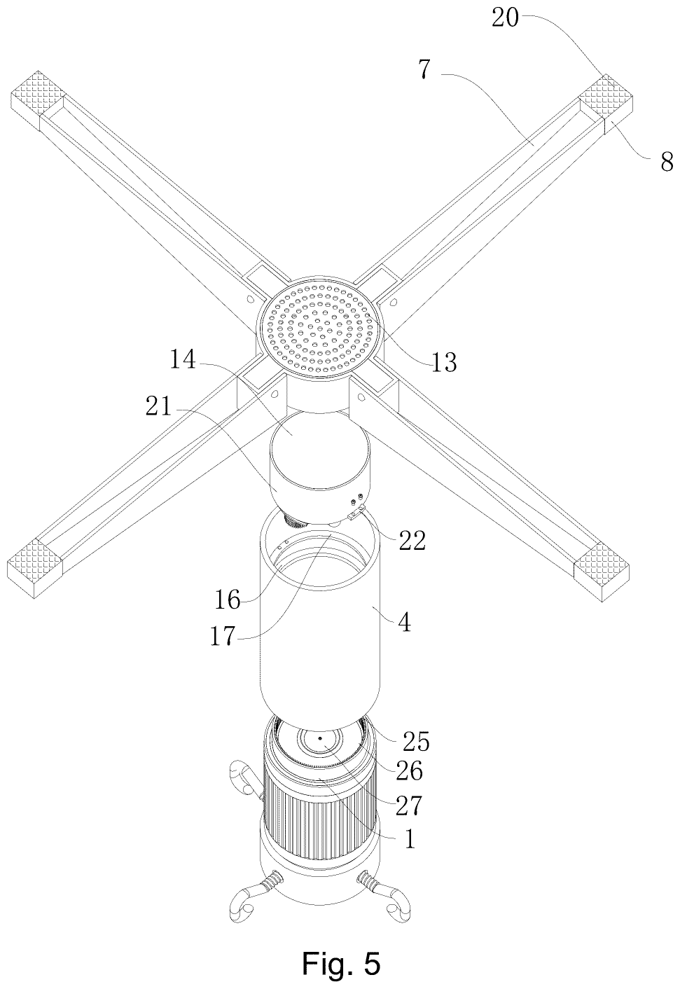

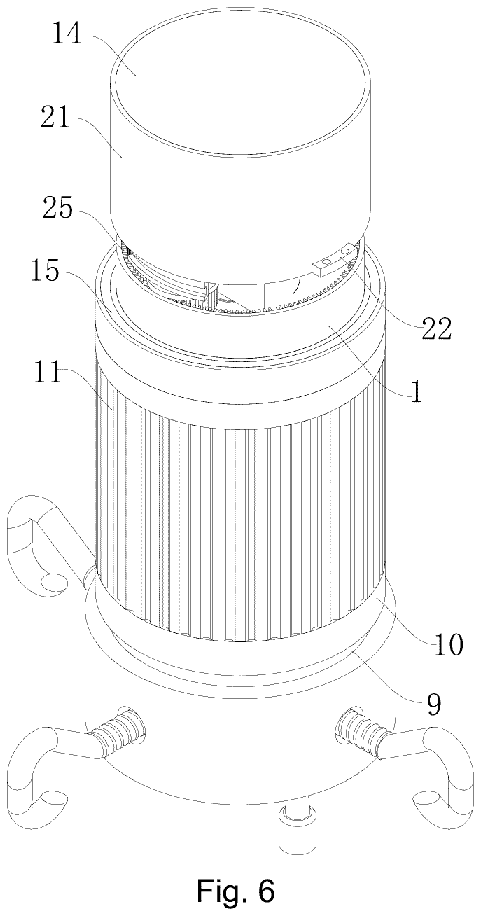

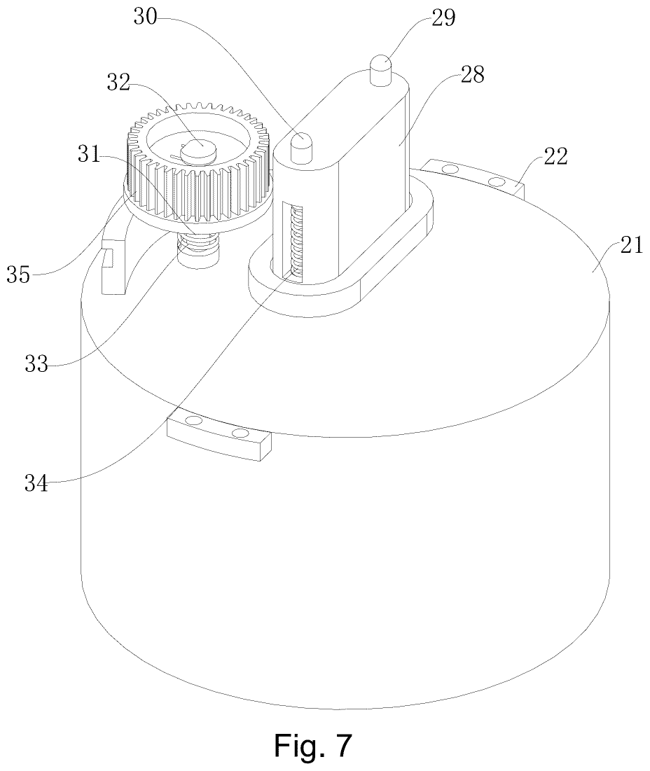

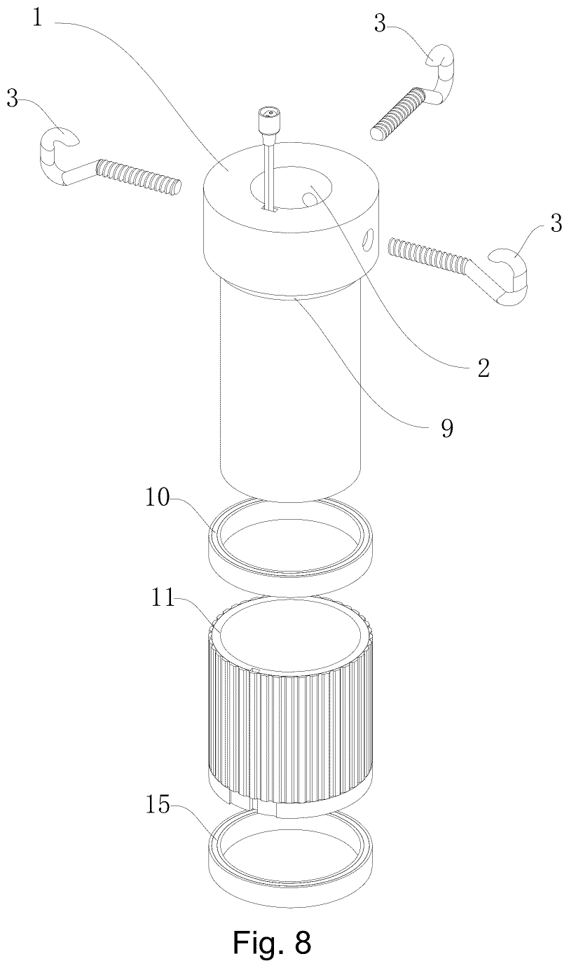

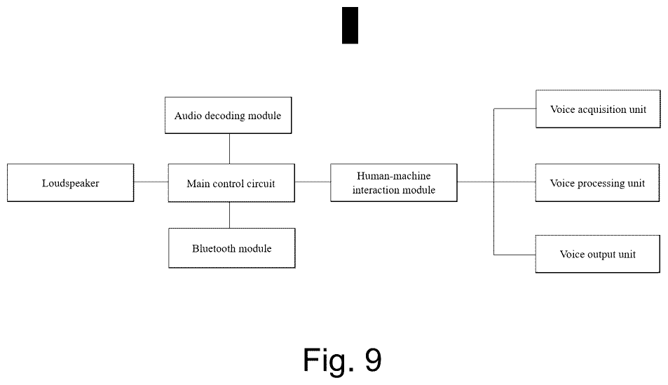

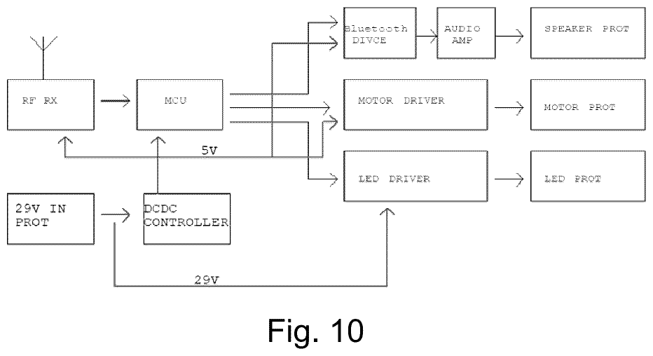

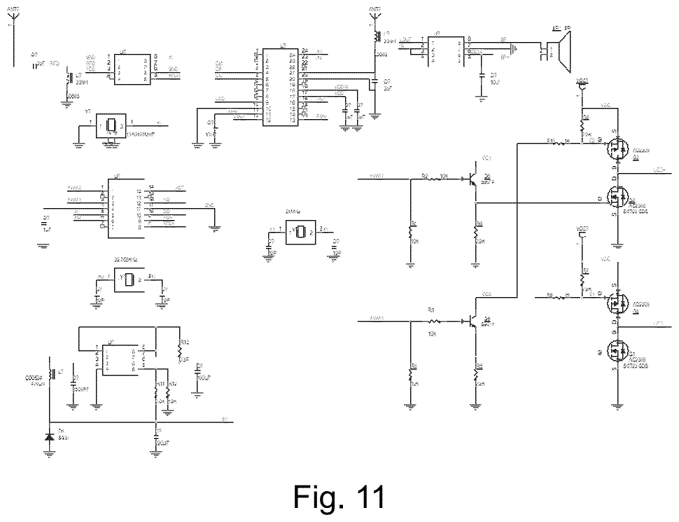

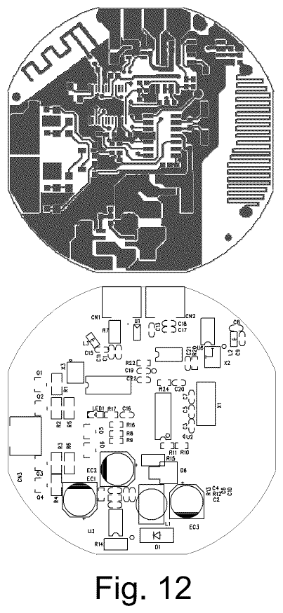

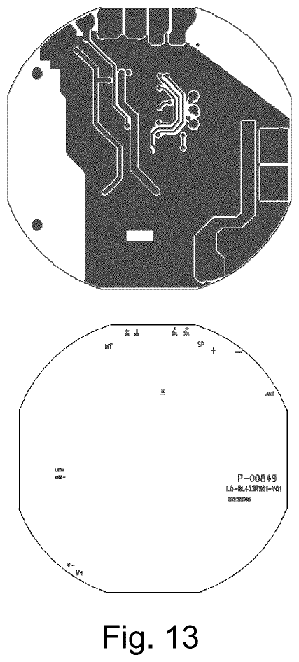

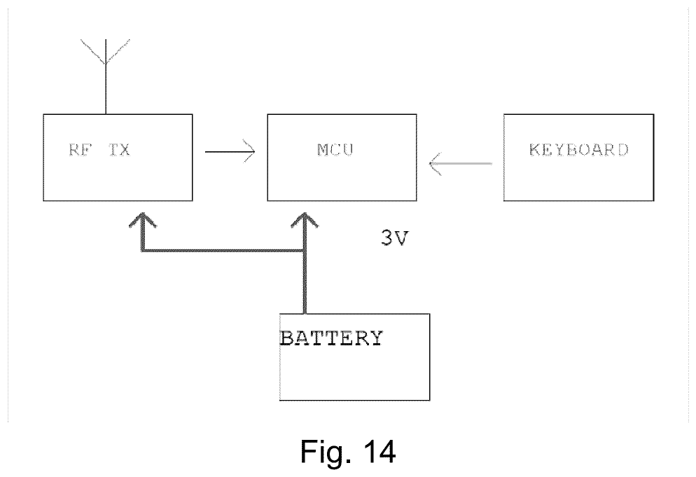

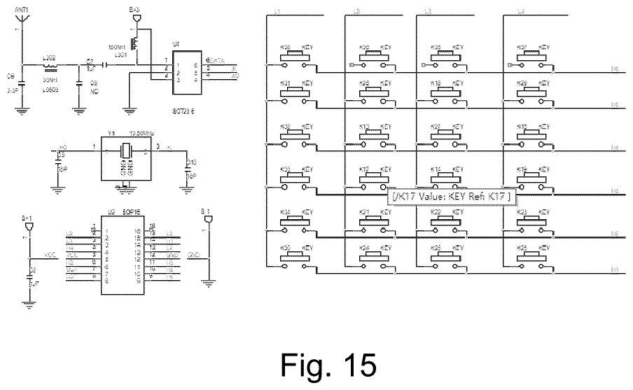

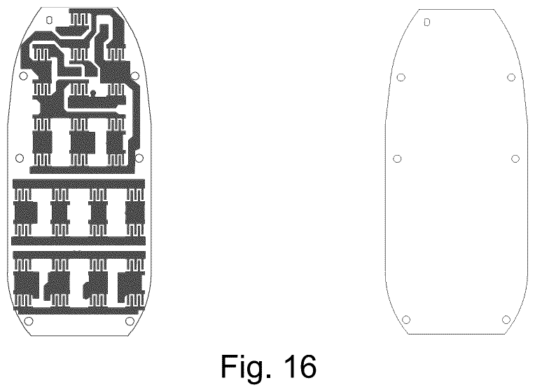

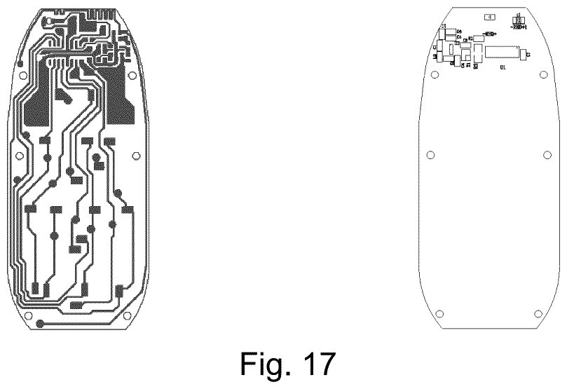

As shown in FIG. 1-17, the invention provides a Christmas tree stand, which comprises a rotating seat 1, a fixing seat 4, a socket 36, a driving mechanism 18, a bottom cover 6 and a plurality of supporting legs 7, wherein the bottom cover 6 is arranged at the bottom of the fixing seat 4 and is firmly connected to the fixing seat 4 through bolts, a plurality of supporting legs 7 are distributed in a circular array around the bottom cover 6, and each supporting leg 7 is connected to the bottom cover 6 through a hinge structure, making the supporting legs 7 rotate relative to the bottom cover 6. When not in use, the supporting legs 7 can be quickly folded up, reducing the overall size of the product and facilitating storage and transportation. Additionally, pads 8 are fixedly arranged at the end of the supporting legs 7 away from the bottom cover 6, and an anti-slip protrusion 20 is fixedly arranged at the bottom end of the pad 8, thereby enhancing the anti-slip effect.

The invention also comprises a voltage transformer plug, a conductive slip ring and a controller., the conductive slip ring is located in the fixing seat 4, the voltage transformer plug is electrically connected to the conductive slip ring, and the conductive slip ring is electrically connected to the controller.

A slot 2 is arranged in the middle of the rotating seat 1 to accommodate the bottom of the trunk of a Christmas tree; the Christmas tree stand also comprises at least one fastening screw 3, one end of the fastening screw 3 is inserted into the slot 2 along the radial direction from the outside of the rotating seat 1, and the fastening screw 3 is screwed onto the rotating seat 1. By tightening the fastening screws 3, uniform and effective clamping force can be applied to the bottom of the trunk of the Christmas tree inserted into slot 2, thereby flexibly adapting to Christmas trees of different specifications and sizes, and ensuring that the Christmas tree is firmly and stably installed on the rotating seat 1. In this embodiment, a total of three fastening screws 3 are provided, which work together to adjust the center of gravity of the Christmas tree. Decorative light strips serving a decorative purpose are hung on the Christmas tree and electrically connected to the socket 36; the transformer plug is connected to the mains supply, transforms the voltage of the mains supply to supply power to the invention; the conductive slip ring is used to meet the requirement of continuous power supply while the controller rotates; the conductive slip ring belongs to the prior art, and its structure will not be elaborated here.

In addition, the rotating seat 1 is provided with a wiring duct 37, the socket 36 is electrically connected to the controller through a wire, which passes through the wiring duct 37, the driving mechanism 18 is connected to the rotating seat 1 to drive rotating seat 1 to rotate, the rotating seat 1 drives the controller, the socket 36 the Christmas tree inserted in the slot 2 to rotate synchronously with the rotating seat 1, and the wire connected to the socket 36 and running through the wiring duct 37 also rotate along with the rotating seat 1, thereby resolving the wiring arrangement issues for the decorative light strips and preventing wire entanglement during the rotation.

The following are the specific structures and connections among the rotating seat 1, the fixing seat 4 and the driving mechanism 18:

The middle and lower ends of the rotating seat 1 are inserted into an internal cavity of the fixing seat 4, a clearance 5 is provided between the top end of the rotating seat 1 and the top end of the fixing seat 4 to facilitate the rotation of the rotating seat; the driving mechanism 18 is fixedly installed in the internal cavity of the fixing seat 4, so that the rotating seat 1 and the driving mechanism 18 are coaxially arranged. Specifically, positioning bumps 9 are formed on the outer wall of the rotating seat 1. A first bearing 10, a sleeve 11 and a second bearing 15 are successively sleeved at the middle and lower ends of the rotating seat 1. A first annular bump 16 is formed on the inner wall of the fixing seat 4. The first bearing 10 is arranged at the bottom of the positioning bumps 9 and abutted against the positioning bumps 9 to provide upper support for the rotating seat 1 and ensure that the rotating seat 1 keep balance during operation. The second bearing 15 is arranged on the surface of the first annular bump 16 and abutted against the first annular bump 16. This abutment arrangement ensures that the second bearing 15 can stably withstand axial and radial forces during rotation and prevents the weight of the Christmas tree from pressing on the driving mechanism 18 and the conducting component. This significantly improves the overall load-bearing capacity, effectively prolongs the service life of the driving mechanism 18 and the conducting component, and reduces vibration and noise. The sleeve 11 is arranged between the first bearing 10 and the second bearing 15, and the upper and lower end faces of the sleeve 11 are respectively abutted against the first bearing 10 and the second bearing 15, forming a stable support structure, effectively restricting the installation positions of the first bearing 10 and the second bearing 15, preventing axial movement during rotation, and ensuring the accuracy and stability of the entire rotating system. The sleeve 11 is firmly connected to the fixing seat 4 through bolts, further restricting the positions of the first bearing 10 and the second bearing 15. The driving mechanism 18 comprises an installation housing 21 and at least one connecting piece 22 formed around the periphery of the installation housing 21. A second annular bump 17 is formed on the inner wall of the fixing seat 4, and the connecting piece 22 is arranged at the bottom of the second annular bump 17 and firmly connected to the second annular bump 17.

Annular external teeth 25 are arranged on the bottom side wall of the rotating seat 1. The driving mechanism 18 comprises a driving component 14 and a transmission gear 35. The driving component 14 is assembled on the installation housing 21, the driving component 14 is a motor, which drives the transmission gear 35 to rotate. The transmission gear 35 is engaged with the annular external teeth 25 to enable the rotating seat 1 to rotate relative to the fixing seat 4. Since the rotating seat 1 and the driving mechanism 18 are coaxially assembled in the internal cavity of the fixing seat 4, the transmission gears 35 and annular external teeth 25 are always in an ideal engaged state. The force is transmitted precisely along the axis direction when the driving component 14 drives the transmission gear 35 to rotate, avoiding transmission shock and vibration caused by eccentricity or angular misalignment. This ensures that the rotating seat 1 rotates smoothly during the rotation process without jamming, and significantly enhances the transmission smoothness. Additionally, this coaxial assembly allows for efficient space utilization by closely integrating the driving mechanism 18 with the rotating seat 1, avoiding additional complex transmission structures and redundant space occupation, resulting in a more compact and streamlined device structure.

In this embodiment, the drive circuit of the motor is provided with a current detection module, an H-bridge drive circuit, a microcontroller and a counter electromotive force detection circuit. The current detection module is used to collect the motor current in real time, the H-bridge drive circuit connects the motor to the power supply and adjusts the rotation direction of the motor according to the control signal. The microcontroller operates the overload protection algorithm and outputs a reverse control signal to the H-bridge when the current exceeds the threshold. Therefore, when the Christmas tree rotates and encounters resistance, the motor rotates in the opposite direction, achieving overload protection and independent escape. It should be noted that the specific operating principle of the overload protection and reverse control in the above-mentioned motor drive circuit are not the core protection object of this technical proposal; they merely provide conventional technical support to ensure that the motor rotates in the opposite direction upon encountering resistance during the rotation of the Christmas tree.

A transmission groove is arranged in the middle of the transmission gear 35, a transmission shaft 31 matching the shape of the transmission groove is arranged at the output end of the driving component 14. A first elastic element 33 is sleeved on the outside of the transmission shaft 31. The two ends of the first elastic element 33 are respectively abutted against the lower end face of the transmission gear 35 and the inner wall of the installation housing 21 to enable the transmission gear 35 to perform longitudinal displacement relative to the transmission shaft 31. A limit bump 32 is formed at the top of the transmission shaft 31 to prevent the transmission gear 35 from detaching from the transmission shaft 31. In this embodiment, the first elastic element 33 is a spring. When the backlash between the transmission gear 35 and the annular external teeth 25 tends to increase due to external factors, the elastic element exerts a force on the transmission gear 35 by its own elastic deformation capacity, pushing the transmission gear 35 to move towards the annular external teeth 25. Conversely, when the backlash decreases, the elastic element is compressed, preventing excessive extrusion stress between the transmission gear 35 and the annular external teeth 25. This design automatically compensates for clearance changes caused by various factors, ensuring that the two always maintain a tight and optimal engaged state, and guaranteeing the efficient and stable operation of the transmission system.

The driving mechanism 18 also comprises a conducting component assembled on the installation housing 21. The conducting component comprises a mounting base 28, a first conducting column 29 and a second conducting column 30, a first electrode plate 26 and a second electrode plate 27 are arranged at the bottom of the rotating seat 1. The first conducting column 29 is electrically connected to the first electrode plate 26, and the second conducting column 30 is electrically connected to the second electrode plate 27. The mounting base 28 is provided with two sliding grooves, each fitted with a second elastic element 34. The first conducting column 29 and the second conducting column 30 are respectively connected to the corresponding second elastic elements 34, so that the first conducting column 29 and the second conducting column 30 slide upwards and downwards inside the sliding grooves. In this embodiment, the second elastic element 34 is a spring, and the ends of the first conducting column 29 and the second conducting column 30 are shaped as circular surfaces, allowing them to form surface contact with the corresponding first electrode plate 26 and the second electrode plate 27. One second elastic element 34 pushes the first conducting column 29 to move towards the first electrode plate 26, another second elastic element 34 drives the second conducting column 30 to move towards the second electrode plate 27. The positions of the first conducting column 29 and the second conducting column 30 are automatically adjusted via the elastic deformation capacity of the spring, thereby maintaining the pre-tightening force between the first conducting column 29 and the first electrode plate 26, as well as between the second conducting column 30 and the second electrode plate 27, and thus ensuring stable contact.

The bottom cover 6 is hollow inside, forming a mounting cavity 12, in which a loudspeaker and a controller are installed. The controller comprises a main control circuit board, the main control circuit board is electrically connected to the loudspeaker to achieve the transmission of audio signals. An MCU module, a Bluetooth module, an audio decoding module and a human-machine interaction module are integrated on the main control circuit board. The Bluetooth module enables wireless connection with other Bluetooth devices to achieve the transmission of audio data. The audio decoding module decodes and converts the received audio data into signals that the loudspeaker can recognize. The human-machine interaction module comprises a voice acquisition unit, a voice processing unit and a voice output unit. The voice acquisition unit captures the user's voice instructions, the voice processing unit analyzes and processes the collected voice to identify the user's intention, and the voice output unit feeds back the processing results to the user in the form of voice, facilitating convenient human-machine interaction. It should be noted that the above-mentioned “other Bluetooth devices” include smart phones or tablet computers, smart remote controls or voice assistant devices, etc. By installing an APP, a graphical interface control can also be achieved. The specific operating principles and structural details of the Bluetooth module, the audio decoding module and the human-machine interaction module are not the core protected objects of this technical proposal but serve as the conventional technical support to enable the Christmas tree stand to perform Bluetooth connectivity, audio playback and human-machine interaction.

In this embodiment, a wireless transceiver module and a memory module are integrated on the main control circuit board. The wireless transceiver module is a 433m wireless transceiver, and the main control circuit board also comprises a remote control wirelessly connected to the wireless transceiver module, with a control range of the remote control is 8 to 10 meters. This configuration allows the user to transmit various command signals to the wireless transceiver module through the remote control. The wireless transceiver module then transmits the received command signals to the main control circuit board, and then controls the start, stop or speed of the driving mechanism 18 as well as the switching on/off of the decorative light strips through the main control circuit board. Moreover, the user can send command signals for playing music to the wireless transceiver module via the remote control. The wireless transceiver module transmits the received command signals to the main control circuit board, the main control circuit board controls the operation of the audio decoding module. The audio decoding module decodes the audio stored in the memory module and plays through the loudspeaker. Thus, multiple functions can be controlled by the remote control, featuring sensitive and applicable functional effects.

The bottom cover 6 is provided with a sound outlet hole 13, whose position corresponds to that of the loudspeaker. The sound outlet hole 13 is used to clearly transmit the sound emitted by the loudspeaker, ensuring that users can enjoy a good auditory experience.

Compared with traditional technologies:

1. Each supporting leg 7 is connected to the bottom cover 6 through the hinge structure, making the supporting legs 7 rotate relative to the bottom cover 6. When not in use, the supporting legs 7 can be quickly folded up, reducing the overall size of the product and facilitating storage and transportation.

2. By tightening the fastening screws 3, a uniform and effective clamping force can be applied to the bottom of the trunk of the Christmas tree inserted into slot 2, thereby flexibly adapting to Christmas trees of different specifications and sizes, and ensuring that the Christmas tree is firmly and stably installed on the rotating seat 1. In this embodiment, a total of three fastening screws 3 are provided, which work together to adjust the center of gravity of the Christmas tree.

3. The first bearing 10 is arranged at the bottom of the positioning bumps 9 and abutted against the positioning bumps 9 to provide upper support for the rotating seat 1 and ensure that the rotating seat 1 keep balance during operation. The second bearing 15 is arranged on the surface of the first annular bump 16 and abutted against the first annular bump 16. This abutting method guarantees that the second bearing 15 can stably withstand axial and radial forces during rotation, significantly enhancing the overall load-bearing capacity, and reducing vibration and noise. The sleeve 11 is arranged between the first bearing 10 and the second bearing 15, and the upper and lower end faces of the sleeve 11 are respectively abutted against the first bearing 10 and the second bearing 15. This forms a stable support structure, effectively restricting the installation positions of the first bearing 10 and the second bearing 15, preventing axial movement during rotation, and ensuring the accuracy and stability of the entire rotating system.

4. Since the rotating seat 1 and the driving mechanism 18 are coaxially assembled in the internal cavity of the fixing seat 4, transmission gears 35 and annular external teeth 25 maintain an ideal engaged state. This coaxial arrangement ensures that the force is transmitted along the precise axis direction when the driving component 14 drives the transmission gear 35 to rotate, avoiding transmission shock and vibration caused by eccentricity or angular deviation. As a result, the rotating seat 1 smoothly rotates during the rotation process without jamming, significantly enhances the transmission smoothness. Additionally, this configuration allows for optimal use of space by closely integrating the driving mechanism 18 with the rotating seat 1, eliminating additional complex transmission structures and redundant space occupation, thereby creating a more compact and streamlined device structure.

5. The first elastic element 33 is a spring. When the backlash between the transmission gear 35 and the annular external teeth 25 tends to increase due to external factors, the elastic element exerts a force on the transmission gear 35 by its own elastic deformation capacity, pushing the transmission gear 35 to move towards the annular external teeth 25. Conversely, when the backlash decreases, the elastic element is compressed, avoiding excessive extrusion stress between the transmission gear 35 and the annular external teeth 25. This mechanism automatically compensates for clearance variations caused by various factors, ensuring that the two always maintain a tight and optimal engaged state, thereby guaranteeing the efficient and stable operation of the transmission system.

6. The second elastic element 34 is a spring, and the ends of the first conducting column 29 and the second conducting column 30 are designed as circular shapes, forming surface contact with the corresponding first electrode plate 26 and the second electrode plate 27. One second elastic element 34 pushes the first conducting column 29 to move towards the first electrode plate 26, another second elastic element 34 drives the second conducting column 30 to move towards the second electrode plate 27. The positions of the first conducting column 29 and the second conducting column 30 are automatically adjusted by utilizing the elastic deformation capacity of the spring, thereby maintaining the pre-tightening force between the first conducting column 29 and the first electrode plate 26, as well as between the second conducting column 30 and the second electrode plate 27, and thus ensuring stable contact.

7. The Bluetooth module can wirelessly connect with other Bluetooth devices to achieve the transmission of audio data. The audio decoding module decodes and converts the received audio data into signals that the loudspeaker can recognize. The voice acquisition unit collects the user's voice instructions, the voice processing unit analyzes and processes the collected voice to identify the user's intention. The voice output unit feeds back the processing results to the user in the form of voice, achieving convenient human-machine interaction.

Those skilled in the art will recognize that the invention is not limited to the details of the exemplary embodiments described above and can be implemented in other specific forms without departing from the spirit or essential characteristics of the invention. Therefore, the embodiments should be regarded as exemplary and non-restrictive in every respect. The scope of the invention is defined by the appended claims rather than the foregoing description, and all modifications that fall within the meaning and range of equivalency of the claims are intended to be embraced therein. No reference signs in the claims should be interpreted as limiting the claims in question.

1. A Christmas tree stand, comprising a rotating seat, a fixing seat, a driving mechanism and a plurality of supporting legs, a slot is arranged in the middle of the rotating seat to accommodate the bottom of the trunk of a Christmas tree, characterized in that the middle and lower ends of the rotating seat are inserted into an internal cavity of the fixing seat, the driving mechanism is fixedly installed in the internal cavity of the fixing seat, so that the rotating seat and the driving mechanism are coaxially arranged, and the driving mechanism is connected to the rotating seat to drive the rotating seat and the Christmas tree to rotate synchronously.

2. The Christmas tree stand according to claim 1, characterized in that positioning bumps are formed on the outer wall of the rotating seat, a first bearing, a sleeve and a second bearing are successively sleeved at the middle and lower ends of the rotating seat, a first annular bump is formed on the inner wall of the fixing seat, the second bearing is arranged on the surface of the first annular bump and abutted against the first annular bump, the first bearing is arranged at the bottom of the positioning bumps and abutted against the positioning bumps, the sleeve is arranged between the first bearing and the second bearing, upper and lower end faces of the sleeve are respectively abutted against the first bearing and the second bearing, the sleeve is firmly connected to the fixing seat, and a clearance is reserved between the top of the rotating seat and the top of the fixing seat;
the driving mechanism comprises an installation housing and at least one connecting piece formed on the periphery of the installation housing, a second annular bump is formed on the inner wall of the fixing seat, and the connecting piece is arranged at the bottom of the second annular bump and firmly connected to the second annular bump.

3. The Christmas tree stand according to claim 2, characterized in that annular external teeth are arranged on the bottom side wall of the rotating seat, the driving mechanism comprises a driving component and a transmission gear, the driving component is assembled on the installation housing and drives the transmission gear to rotate, and the transmission gear is engaged with the annular external teeth to enable the rotating seat to rotate relative to the fixing seat.

4. The Christmas tree stand according to claim 3, characterized in that the driving mechanism also comprises a conducting component assembled on the installation housing, the conducting component comprises a mounting base, a first conducting fixing seat and a second conducting fixing seat, a first electrode plate and a second electrode plate are arranged at the bottom of the rotating seat, the first conducting fixing seat is electrically connected to the first electrode plate, and the second conducting fixing seat is electrically connected to the second electrode plate.

5. The Christmas tree stand according to claim 3, characterized in that a transmission groove is arranged in the middle of the transmission gear, a transmission shaft matching the shape of the transmission groove is arranged at the output end of the driving component, a first elastic element is sleeved on the outside of the transmission shaft, two ends of the first elastic element are respectively abutted against the lower end face of the transmission gear and the inner wall of the installation housing to enable the transmission gear to perform longitudinal displacement relative to the transmission shaft, and a limit bump is formed at the top of the transmission shaft to prevent the transmission gear from detaching from the transmission shaft.

6. The Christmas tree stand according to claim 4, characterized in that the mounting base provided with two sliding grooves, a second elastic element is assembled in each sliding groove, and the first conducting fixing seat and the second conducting fixing seat are respectively connected to the corresponding second elastic elements, so that the first conducting fixing seat and the second conducting fixing seat slide up and down inside the sliding grooves.

7. The Christmas tree stand according to claim 1, characterized in that a bottom cover firmly connected to the fixing seat is arranged at the bottom of the fixing seat, a plurality of supporting legs are distributed in a circular array around the bottom cover, and each supporting leg is connected to the bottom cover through a hinge structure, making the supporting legs rotate relative to the bottom cover.

8. The Christmas tree stand according to claim 7, characterized in that the bottom cover is hollow inside to form a mounting cavity, a loudspeaker and a main control circuit board are assembled in the mounting cavity, the main control circuit board is electrically connected to the loudspeaker, and the bottom cover is provided with a sound outlet hole.

9. The Christmas tree stand according to claim 8, characterized in that a wireless transceiver module, a memory module, a Bluetooth module, an audio decoding module and a human-machine interaction module are integrated on the main control circuit board, and the human-machine interaction module comprises a voice acquisition unit, a voice processing unit and a voice output unit.

10. The Christmas tree stand according to claim 1, characterized by also comprising at least one fastening screw, one end of the fastening screw is inserted into the slot along the radial direction from the outside of the rotating seat, and the fastening screw is screwed onto the rotating seat.
